(19) United States
(12) Patent Application Publication
(10) Pub. No.: US 2025/0046951 A1
(43) Pub. Date: Feb. 6, 2025

(54) TWO-SIDE-COATED BATTERY SEPARATOR AND BATTERY COMPRISING THE SAME

(71) Applicant: Celgard, LLC, Charlotte, NC (US)

(72) Inventors: Wenbin Yin, Charlotte, NC (US); Zhengming Zhang, Rock Hill, SC (US)

(21) Appl. No.: 18/716,506

(22) PCT Filed: Dec. 13, 2022
(86) PCT No.: PCT/US2022/052643

§ 371 Date: Jun. 4, 2024

Related U.S. Application Data
(60) Provisional application No. 63/288,823, filed on Dec. 13, 2021.

(51) Int. Cl. H01M 50/457; H01M 50/426; H01M 50/434

(52) U.S. Cl. CPC H01M 50/457; H01M 50/426; H01M 50/434

(57) ABSTRACT

A two-side coated battery separator that has an adhesive layer on each side is described. The adhesive layer on one side is formed from a different coating formulation than the adhesive layer on an opposite side. In some embodiment, an adhesive layer on one side is formed on top of a ceramic layer and an adhesive layer on the other side is formed directly on the battery separator. A battery comprising this two-side coated battery separator is also described.

### RELATED APPLICATIONS DATA

This Application is a 371 U.S. Application which claims priority to PCT Application No. PCT/US2022/052643, filed Dec. 13, 2022, which claims priority to U.S. Provisional Application No. 63/288,823, which was filed on Dec. 13, 2021 and is incorporated herein in its entirety.

### FIELD

The application is directed to two-side coated battery separators, and particularly, adhesive two-side-coated battery separators. Also, this application is directed to secondary batteries comprising the two-side-coated battery separator.

### BACKGROUND

A Multilayer-coated separator (MCS) includes a coating with two or more layers on at least one side of the battery separator. For example, an MCS may comprise a two-layer coating on at least one side where the first layer of the coating, which is formed closest to the surface of the separator, is a ceramic layer. An adhesive layer may be formed on top of the ceramic layer. A thin adhesive coating is preferred because it contributes less to the overall thickness of the coated separator, and a thinner battery separator is preferred from a standpoint of battery capacity. The thinner a separator is, the more separators, electrodes, etc. that can be accommodated in the same space, leading to higher capacity. However, when a thin adhesive is formed, ceramic particles from the underlying ceramic layer may protrude through the adhesive layer causing reduced adhesion in those spots. FIG. 1 shows protrusion of ceramic particles of a ceramic coating through an adhesive layer in an MCS.

When adhesion on one side of a two-side coated battery separator is very different than adhesion on the other side, the battery separator may stick to one electrode better than to another. This is not favorable. It is favorable for adhesion on the two sides to be equal or approximately equal.

Thus, an MCS with improved adhesion are desirable.

### SUMMARY

The battery separator described hereinabove. For-example, the battery separator described herein may provide improved adhesion.

In one aspect, a two-side-coated battery separator comprising a first coating on one side of the separator and a second coating on a second side of the separator. In some embodiments, the first coating may be a single or multilayer coating comprising one or more coating layers. An outer-most coating layer of the first coating is an adhesive coating layer. The second coating of the two-side-coated battery separator may be a multilayer coating having two or more layers. The second coating may comprise a ceramic coating layer and an adhesive coating layer on top of the ceramic coating layer. The adhesive coating layer is an outermost layer of the second coating. In preferred embodiments, the adhesive coating layer of the first coating and the adhesive coating layer of the second coating are formed from different coating formulations. In particularly preferred embodiments, the coating formulation used to form the adhesive coating layer of the second coating is more adhesive that that used to form the adhesive coating layer of the first coating. For example, the formulation may be 5 N/m more adhesive, 7 N/m more adhesive, or 10 N/m more adhesive.

In some preferred embodiments, the adhesive coating layer of the first or second coating has a thickness of 1 micron or less.

In some preferred embodiments, the coating formulation used to form the adhesive coating of the first or second coating comprises PVDF, a binder, and water as a solvent. In some embodiments, the coating formulation may further comprise less than 10% or less than 5% nano-ceramic.

In another aspect, a secondary battery comprising the two-side-coated battery separator disclosed herein is described.

### BRIEF DESCRIPTION OF THE DRAWINGS

FIG. 1 is a schematic drawing of a two-side-coated battery separator according to some embodiments described herein.

FIG. 2 is a schematic drawing of a two-side-coated battery separator according to some embodiments described herein.

FIG. 3 is a schematic drawing of a secondary battery according to some embodiments described herein.

### DESCRIPTION

Accordingly, embodiments described herein can be understood more readily by reference to the following detailed description, examples, and figures. Elements, apparatus, and methods described herein, however, are not limited to the specific embodiments presented in the detailed description, examples, and figures. It should be recognized that the exemplary embodiments herein are merely illustrative of the principles of the invention. Numerous modifications and adaptations will be readily apparent to those of skill in the art without departing from the spirit and scope of the invention.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

Many different arrangements of the various components and/or steps depicted and described, as well as those not shown, are possible without departing from the scope of the claims below. Embodiments of the present technology have been described with the intent to be illustrative rather than restrictive. Alternative embodiments will become apparent from reference to this disclosure. Alternative means of implementing the aforementioned can be completed without departing from the scope of the claims below. Certain features and subcombinations are of utility and can be employed without reference to other features and subcombinations and are contemplated within the scope of the claims.

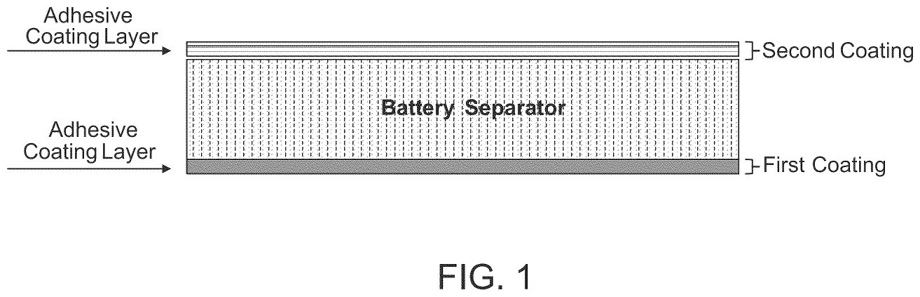

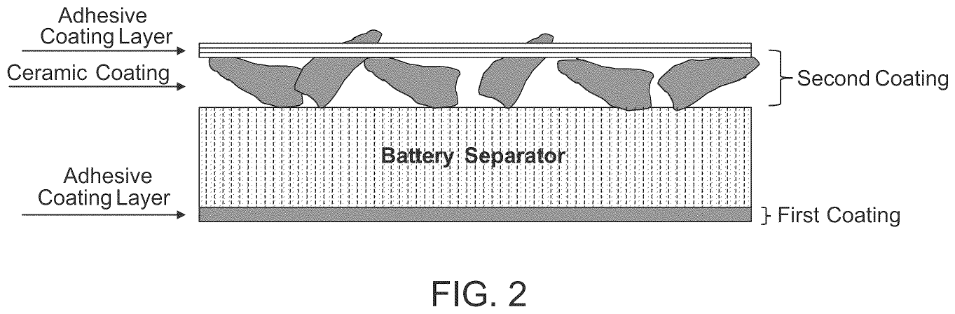

This application is directed to a two-side coated battery separator with a first coating on one side of the battery separator and a second coating on the opposite side of the battery separator. Each coating may have one, two, three, four, or more coating layers. An outermost coating layer of each of the first coating and the second coating is an adhesive coating layer. In preferred embodiments, the outermost adhesive coating layers are formed using different coating formulations. One of the coating formulations forms a stickier coating than the other. For example, one of the coating formulations may form a coating that is 5 N/m, 7 N/m, or 10 N/m more adhesive. FIG. 1 includes an embodiment as described herein where each of the first and second coating comprise one coating layer. The one coating layer is an adhesive coating layer that is an outermost layer of the first and second coating. FIG. 2 includes an embodiment where the second coating comprises two coating layers and the first coating comprises one. The outermost coating layer of each coating is an adhesive coating layer.

In some particularly preferred embodiments, a two-side-coated battery separator like that shown in FIG. 2 is described. The two-side-coated battery separator comprises a first coating with at least one coating layer and a second coating with at least two coating layers. Each of the first and second coating may comprise more coating layers. In preferred embodiments, the outermost coating layer of the first coating is an adhesive coating layer, and the second coating comprises, at least, a ceramic coating layer and an adhesive coating layer on top of the ceramic coating layer. The adhesive coating layer on top of the ceramic coating layer is an outermost coating layer (i.e., a layer with no further layers formed on top thereof) of the second coating. In particularly preferred embodiments, the adhesive coating layer on top of the ceramic coating layer is formed using a coating formulation that is more adhesive that the coating formulation used to form the other outermost adhesive coating layer. For example, the coating formulation may form a coating that is 5 N/m, 7 N/m, or 10 N/m more adhesive.

In some preferred embodiments, the outermost adhesive coating layers may be thin. For example, they may have a thickness less than 2 microns, less than 1.5 microns, less than 1 micron, less than 0.9 microns, less than 0.8 microns, less than 0.7 microns, less than 0.6 microns, less than 0.5 microns, less than 0.4 microns, less than 0.3 microns, less than 0.2 microns, or less than 0.1 microns. Thin adhesive coating layers may exhibit reduced adhesion when formed on top of a ceramic coating layer due to the fact that ceramic particles of the ceramic coating layer may protrude through the adhesive coating layer as shown in FIG. 2. This results in areas of the adhesive coating layer with reduced adhesion. Forming the adhesive coating layer with a coating formulation that is more adhesive may mitigate this issue.

### Battery Separator

The battery separator of the two-side-coated battery separator described herein is not so limited, and any battery separator capable of being used in a secondary battery, e.g., a lithium ion battery, may be used. In some preferred embodiments, the battery separator may comprise, consist of, or consist essentially of polyolefins. The battery separator may be nanoporous, microporous, mesoporous, or macroporous. The battery separator may be a monolayer, bi-layer, tri-layer, or multi-layer battery separator. In some preferred embodiments, the battery separator may be one formed by a dry-process that does not utilize solvents or oils. In some embodiments, the dry-process may be a dry-stretch process in which a polymer is extruded and stretched to form pores. Stretching may be uniaxial, biaxial, or multi-axial. In other embodiments, the battery separator may be formed by a wet process that does involve the use of solvents or oils to form pores.

### First Coating

The first coating may be a single layer coating, a two-layer coating, a three-layer coating, a four-layer coating, or a five-layer coating. In some embodiments, the first coating may have more than five coating layers. In preferred embodiments, the outermost coating layer of the first coating is an adhesive coating layer. In one preferred embodiment, the first coating is a single layer coating and the single layer is an adhesive coating layer.

The adhesive coating is not so limited. In some embodiments, the adhesive coating may comprise an adhesive polymer. The adhesive polymer may be one or more selected from a polyvinylidene fluoride (PVDF) homopolymer, a PVDF copolymer, PEO, Acrylic polymer, or PVA. For Example, the PVDF co-polymer may be a PVDF-HFP copolymer.

In some embodiments, the adhesive coating layer may be formed using a coating formulation that uses an organic solvent or water as a solvent. In embodiments where water is used as the solvent, a small amount of an alcohol or another water-soluble solvent may be added.

In some preferred embodiments, the adhesive polymer may be insoluble in water. One example of an adhesive polymer that is insoluble in water is PVDF.

In some preferred embodiments, the adhesive coating layer may be formed using a coating formulation that includes less than 10%, less than 9%, less than 8%, less than 7%, less than 6%, or less than 5% nano-ceramic. Nano-ceramic may have an average particle size less than about 500 nm, less than 450 nm, less than 400 nm, less than 350 nm, less than 300 nm, less than 250 nm, less than 225 nm, less than 200 nm, less than 175 nm, less than 150 nm, less than 125 nm, or smaller. The nano-ceramic may comprise iron oxides, silicon dioxide (SiO₂), aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, oxides of transition metals, graphite, carbon, metal, and any combinations thereof.

In some preferred embodiments, the adhesive coating layer may have a thickness of less than 2 nm, less than 1.9 nm, less than 1.8 nm, less than 1.7 nm, less than 1.6 nm, less than 1.5 nm, less than 1.4 nm, less than 1.3 nm, less than 1.2 nm, less than 1.1 nm, less than 1.0 nm, less than 0.9 nm, less than 0.8 nm, less than 0.7 nm, less than 0.6 nm, less than 0.5 nm, less than 0.4 nm, less than 0.3 nm, less than 0.2 nm, or less than 0.1 nm. In embodiments where the first coating comprises only a single layer, which is an adhesive coating layer, the total thickness of the first coating is preferably less than 2 nm, less than 1.9 nm, less than 1.8 nm, less than 1.7 nm, less than 1.6 nm, less than 1.5 nm, less than 1.4 nm, less than 1.3 nm, less than 1.2 nm, less than 1.1 nm, less than 1.0 nm, less than 0.9 nm, less than 0.8 nm, less than 0.7 nm, less than 0.6 nm, less than 0.5 nm, less than 0.4 nm, less than 0.3 nm, less than 0.2 nm, or less than 0.1 nm.

### Second Coating

The second coating may be a single layer coating, a two-layer coating, a three-layer coating, a four-layer coating, or a five-layer coating. In some embodiments, the second coating may have more than five coating layers. In preferred embodiments, the outermost coating layer of the second coating is an adhesive coating layer. In some particularly preferred embodiments, the second coating is a two-layer coating that comprise a ceramic coating layer and an adhesive coating layer on top of the ceramic coating layer. The ceramic coating layer may be formed directly on a surface of the battery separator, or there may be one or more intervening layers between the ceramic coating layer and a surface of the battery separator.

The ceramic coating is not so limited, and any ceramic coating suitable for use in a secondary battery, e.g., a lithium-ion battery, may be used. The ceramic coating may, among other things, provide heat-resistance, block dendrites, and the like. The ceramic may comprise iron oxides, silicon dioxide (SiO₂), aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, kaoline, mullite, spinel, olivine, mica, tin dioxide (SnO₂), indium tin oxide, oxides of transition metals, graphite, carbon, metal, and any combinations thereof. The thickness of the ceramic coating may be less than 5 microns, less than 4 microns, less than 3 microns, less than 2 microns, less than 1 micron, or less than 0.5 microns.

The adhesive coating layer of the second coating may be like that used to form the first coating, but the coating formulation used to form the adhesive coating layer of the second coating is preferrably different than the coating formulation used to form the adhesive coating layer of the first coating. For example, the coating formulations may include different adhesive polymers.

In some preferred embodiments, the adhesive coating layer may have a thickness of less than 2 nm, less than 1.9 nm, less than 1.8 nm, less than 1.7 nm, less than 1.6 nm, less than 1.5 nm, less than 1.4 nm, less than 1.3 nm, less than 1.2 nm, less than 1.1 nm, less than 1.0 nm, less than 0.9 nm, less than 0.8 nm, less than 0.7 nm, less than 0.6 nm, less than 0.5 nm, less than 0.4 nm, less than 0.3 nm, less than 0.2 nm, or less than 0.1 nm.

In embodiments where an adhesive coating layer is an outermost layer of the second coating, and the adhesive coating layer is formed on top of a ceramic coating layer, it is preferred that the coating formulation used to form the adhesive coating layer of the second coating is different than the coating formulation used to form the outermost adhesive coating layer of the first coating. The coating formulation used for the second coating, in preferred embodiments, forms a more adhesive coating than the coating formulation used for the first coating. Preferably, the coating formulation forms a coating that is at least 5 N/m, at least 6 N/m, at least 7 N/m, at least 8 N/m, at least 9 N/m, or at least 10 N/m more adhesive. This is tested by separately applying each coating formulation directly onto the same type of substrate, and forming layers of the same thickness. Then, the adhesiveness of the formulations may be tested using the method as described herein.

In some embodiments, the adhesive coating of the second coating may be a discontinuous or a continuous layer. In some preferred embodiments, the adhesive coating of the second coating may be discontinuous. For example, the adhesive layer may be formed using spray coating or dot pattern coating. Use of a non-continuous adhesive layer may have benefits of lowering electrical resistance after heat compressing which benefits high power application, reducing moisture content, and also providing cost-savings.

### Secondary Battery

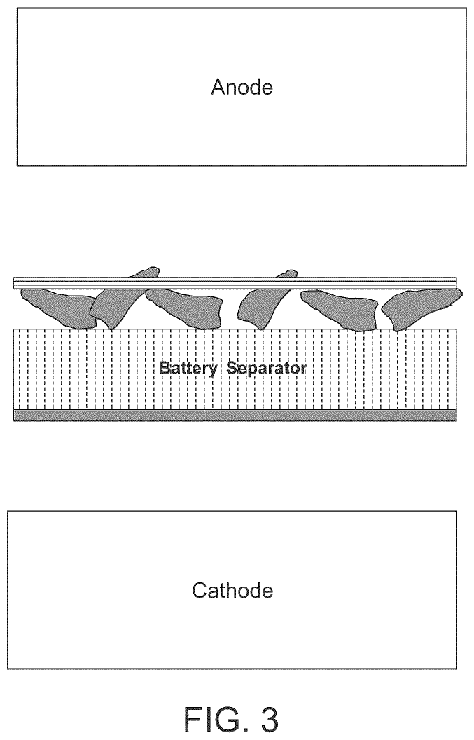

A secondary battery may comprise the two-side-coated battery separator as described hereinabove. In some embodiments, the two-side-coated battery separator may include a ceramic coating layer, and the ceramic coating layer may be on a side of the battery separator that is closest to an anode. See FIG. 3.

### EXAMPLES

### Test for Adhesion

### Prepare Sample:

Coat the formulation used for the outermost adhesive layer of the first coating directly onto a polyolefinic battery separator (1). Coat the formulation used for the outermost adhesive layer of the second coating directly onto the same type of polyolefinic battery separator (2). Cut a 1 inch×7 inch coated separator sample (of 1 and 2). Cut a 1 inch×1 inch electrode material, using the same material for each separator. Place the 1×1 inch electrode on top of the 1×7 sample. The 1×1 electrode should be placed at one end of the 1×7 sample, not in the middle.

Place the samples including the separator with the electrode on top into a paper pouch that is slightly bigger than the size of the electrode material—about 2 inches×2 inches.

### Heating:

Using heat gloves place the pouch containing the sample within the black square (electrode material) on the bottom plate of the heat press as shown above. Clampdown the top plate for 10 seconds. Release the top plate of the heat press. Testing:

Cut a 1×1 inch double-sided tape and place it at the top of a steel plate. Take the heated sample out of the pouch, and place the sample on the steel plate with the electrode side of the sample on the tape.

Use the roller to adhere the sample to the steel plate.

Insert the finished sample into the bottom of the Chatillon roller grip; run through test.

1. A two-side-coated battery separator, comprising:
a first coating on one side of the battery separator that comprises at least one coating layer, wherein an outer-most coating layer of the first coating is an adhesive coating layer; and
a second coating on an opposite side of the battery separator that comprises at least two coating layers, wherein one coating layer of the second coating is a ceramic coating layer and an outer-most coating layer of the second coating is an adhesive coating layer, wherein
the adhesive coating layer of the first coating and the adhesive coating layer of the second coating are formed using different coating formulations.

2. The two-side-coated battery separator of claim 1, wherein a coating formulation used to form the adhesive coating layer of the second coating is more adhesive that a coating formulation used to form the adhesive coating layer of the first coating.

3. The two-side-coated battery separator of claim 2, wherein the coating formulation used to form the adhesive coating layer of the second coating is greater than 5 N/m more adhesive.

4. The two-side-coated battery separator of claim 2, wherein the coating formulation used to form the adhesive coating layer of the second coating is greater than 7 N/m more adhesive.

5. The two-side-coated battery separator of claim 2, wherein the coating formulation used to form the adhesive coating layer of the second coating is greater than 10 N/m more adhesive.

6. The two-side-coated battery separator of claim 1, wherein the outermost coating layer of the second coating is an adhesive coating layer having a thickness of 1 micron or less.

7. The two-side-coated battery separator of claim 1, wherein the outer most coating layer of the first coating is an adhesive coating layer having a thickness of 1 micron or less.

8. The two-side-coated battery separator of claim 6, wherein the outer most coating layer of the first coating is an adhesive coating layer having a thickness of 1 micron or less.

9. The two-side coated battery separator of claim 6, wherein the coating formulation used to form the adhesive coating layer of the second coating comprises PVDF, a binder, and water as a solvent.

10. The two-side coated battery separator of claim 8, wherein the coating formulation used to form the adhesive coating layer of the second coating comprises PVDF, a binder, and water as a solvent.

11. The two-side coated battery separator of claim 6, wherein the coating formulation used to form the adhesive coating layer of the second coating comprises PVDF, a binder, less than 10% nano-ceramic, and water as a solvent.

12. The two-side coated battery separator of claim 8, wherein the coating formulation used to form the adhesive coating layer of the second coating comprises PVDF, a binder, less than 10% nano-ceramic, and water as a solvent.

13. The two-side coated battery separator of claim 6, wherein the coating formulation used to form the adhesive coating layer of the second coating comprises PVDF, a binder, less than 5% nano-ceramic, and water as a solvent.

14. The two-side coated battery separator of claim 8, wherein the coating formulation used to form the adhesive coating layer of the second coating comprises PVDF, a binder, less than 5% nano-ceramic, and water as a solvent.

15. A secondary battery comprising the two-side coated battery separator of claim 1.

16. A two-side-coated membrane, comprising:
a first coating on one side of the membrane that comprises at least one coating layer, wherein an outer-most coating layer of the first coating is an adhesive coating layer; and
a second coating on an opposite side of the membrane that comprises at least two coating layers, wherein one coating layer of the second coating is a ceramic coating layer and an outer-most coating layer of the second coating is an adhesive coating layer, wherein
the adhesive coating layer of the first coating and the adhesive coating layer of the second coating are formed using different coating formulations.

17. The two-side-coated membrane of claim 16, wherein a coating formulation used to form the adhesive coating layer of the second coating is more adhesive that a coating formulation used to form the adhesive coating layer of the first coating.

18. The two-side-coated membrane of claim 16, wherein the adhesive coating layer of the second coating is continuous or discontinuous.

19. The two-side-coated membrane of claim 18, wherein the adhesive coating layer of the second coating is continuous.

20. The two-side-coated membrane of claim 18, wherein the adhesive coating layer of the second coating is discontinuous.

21. The two-side-coated battery separator of claim 1, wherein the adhesive coating layer of the second coating is continuous or discontinuous.

22. The two-side-coated membrane of claim 21, wherein the adhesive coating layer of the second coating is continuous.

23. The two-side-coated membrane of claim 21, wherein the adhesive coating layer of the second coating is discontinuous.

24. The two-side-coated battery separator of claim 1, wherein the adhesive coating layer of the second coating is a spray coating or dot pattern coating.

25. The two-side-coated membrane of claim 21, wherein the adhesive coating layer of the second coating is a spray coating or dot pattern coating.
